(19) United States
(12) Patent Application Publication
(10) Pub. No.: US 2023/0243283 A1
(43) Pub. Date: Aug. 3, 2023

(54) METHOD AND PROCESS FOR MANUFACTURING A UNITARY OIL FILTER ADAPTOR

(71) Applicant: RB Distribution, Inc., Colmar, PA (US)

(72) Inventors: Andrew Setz KELLY, Philadelphia, PA (US); Evan Soda, Perkiomenville, PA (US); Gabriel Kovacs, Abington, PA (US); Robert Pisch, Willow Grove, PA (US); Eric Tryson, Willow Grove, PA (US)

(73) Assignee: RB Distribution, Inc., Colmar, PA (US)

(21) Appl. No.: 18/194,343

(22) Filed: Mar. 31, 2023

Related U.S. Application Data
(63) Continuation of application No. 17/985,565, filed on Nov. 11, 2022, now Pat. No. 11,639,675.
Application No. 17/985,565 is a continuation of application No. 17/528,884, filed on Nov. 17, 2021, now Pat. No. 11,639,674.
Application No. 17/528,884 is a continuation of application No. 17/406,639, filed on Aug. 19, 2021, now Pat. No. 11,635,005.
(60) Provisional application No. 63/068,759, filed on Aug. 21, 2020.

(51) Int. Cl. F01M 11/03

(52) U.S. Cl. CPC F01M 11/03; F01M 2011/033

(57) ABSTRACT

A casted unitary metallic oil filter adaptor that has an entirely internal lubricant flow path and threads for connecting associated components directly to the casted adaptor.

### CROSS REFERENCE TO RELATED APPLICATIONS

This application claims the benefit of U.S. application Ser. No. 17/985,565, which was filed on Nov. 11, 2022; U.S. application Ser. No. 17/528,884, which was filed on Nov. 17, 2021; U.S. application Ser. No. 17/406,639, which was filed on Aug. 19, 2021; and, U.S. Provisional Application No. 63/068,759, filed on Aug. 21, 2020, each of which is incorporated herein by reference as if fully set forth herein.

### FIELD OF INVENTION

The invention relates generally to the lubrication of mechanical engines that utilize oil as a lubricating fluid that circulates though defined galleries in the engine. More particularly, the invention relates to a lubrication system where the lubricating fluid is routinely passed through a filter element, which is generally replaceable at certain intervals, and potentially and oil cooler. Most particularly, the invention relates to an adaptor for a lubrication system that incorporates the oil filter housing and an oil cooler in an assembly that is often located within the motor valley.

### BACKGROUND

Modern engines, especially though used in motor vehicles, seek to reduce weight and size while maintaining the desired power. As part of the effort to reduce weight, many parts are being made in plastic and many parts are being combined in assemblies to further reduce weight by eliminating individual connection points. While this trend has proven successful in some areas, it has introduced problems where one or more portions of a plastic assembly experience a failure. Under these conditions, it is often necessary to disassemble unrelated parts of the engine in order to gain access to the assembly and make the necessary repairs.

Another drawback to plastic assemblies is the need to made accommodations for various sensors and system components that need to be connected to the assembly. These connections are most often achieved by molding an opening in the plastic component and attaching a metallic insert to achieve the connection. This plastic to metal connection can be difficult to properly seal. An addition failure point of this metal-plastic connector is the possibility of over tightening the inserted component, such as a sensor fitting or cap, and stressing or damaging the surrounding plastic.

In addition to the above associated with a hybrid plastic-metallic assembly, the molding process requires certain concessions in order to permit molding cores to be inserted and removed during the molding process. An associated drawback with the plastic molding is the need to remove core elements used in the process and reseal the molding which leads to further potential failure points. In addition, the unused molded openings that require closing plugs that must be glued or welded in the unused openings. These plugs represent another failure point in the plastic-metallic assembly.

### SUMMARY

The applicants have discovered that a cast metallic part provides a robust assembly that avoids the needs for inserts, eliminates the need for plugs, and provides for direct threading of components to the adaptor. As a result of eliminating the assembly of multiple molded parts, the performance and durability is improved against burst pressure, heat and age degradation, and conditions related to cycling. In addition, the single metallic casting provides a flow path without the need for adhesives and resealing of the flow path.

### BRIEF DESCRIPTION OF THE DRAWINGS

FIG. 1 is a perspective view of a prior art oil filter adaptor and cooler assembly;

FIG. 2 is a partial rear view of the prior art assembly in FIG. 1;

FIG. 3A illustrates the capping of the oil flow path in the prior art adaptor after removal of the core used in the plastic molding;

FIG. 3B is a section illustrating the flow path in the prior art adaptor;

FIG. 4 is a perspective view of an adaptor according to the invention prior to assembly of any related components;

FIG. 5 is a section view along the line 5-5 in FIG. 4 showing the linear flow path in an adaptor according to the invention; and,

FIG. 6 is a perspective view of an adaptor according to the invention in a direction opposite to that of FIG. 4.

### DETAILED DESCRIPTION

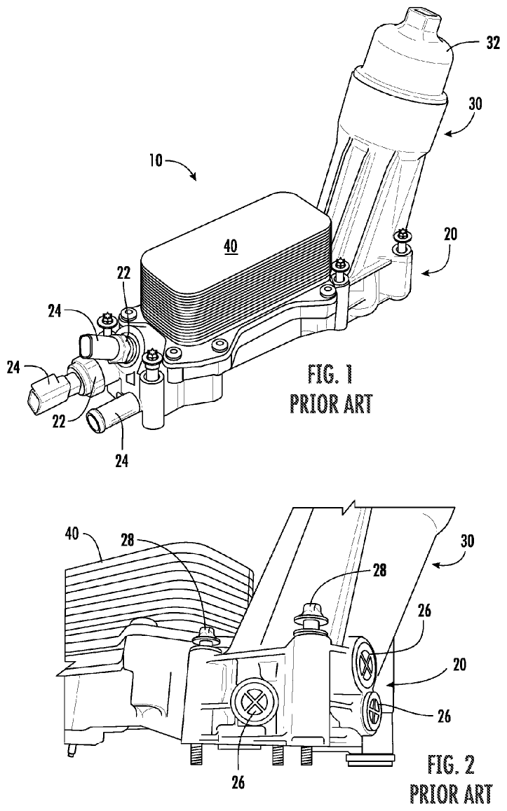

The prior art oil filter assembly shown in FIGS. 1-3B is typical of the adaptor construction resulting from using moldable plastic materials. The prior art assembly 10 in FIG. 1 has a base 20, a filter housing 30 and an oil cooler 40. The base 20 includes medal inserts 22 that are provided in the plastic construction at designated locations for the attachment of other associated components. The metal inserts and associated components are shown in FIG. 1 at 22 and 24 respectively. Although the metal inserts are frequently molded in situ during the molding of the plastic base, they remain a failure point and can result in oil leakage or worse. The metal inserts 22 are also subject to overtightening during attachment of the associated components 24, which can result in stress cracks in the plastic.

As shown in FIG. 2, the base 20, due to the molding process requiring the ability to withdrawal a core, has a number of plugs 26 that are retrofitted after the base 20 is molded. The plugs 26 are assembled to the molded base with an adhesive or spin welding. In either event, the plugs 26 are a failure point in the base 20 that can result in oil leaking or worse.

In addition to the inserts 22 and plugs 26, the base 20 has a number of metal inserts or sleeves, not shown, that are inserted to reinforce the plastic molded apertures for attachment of the various bolts 28 that hold the assembly 10 together. Here again, the inserts or sleeves introduce a potential failure point. Another potential failure point is the attachment of the cap 32 to the plastic filter housing 30. Over tightening of the cap 32 can introduce stress fracture in the threaded housing 30.

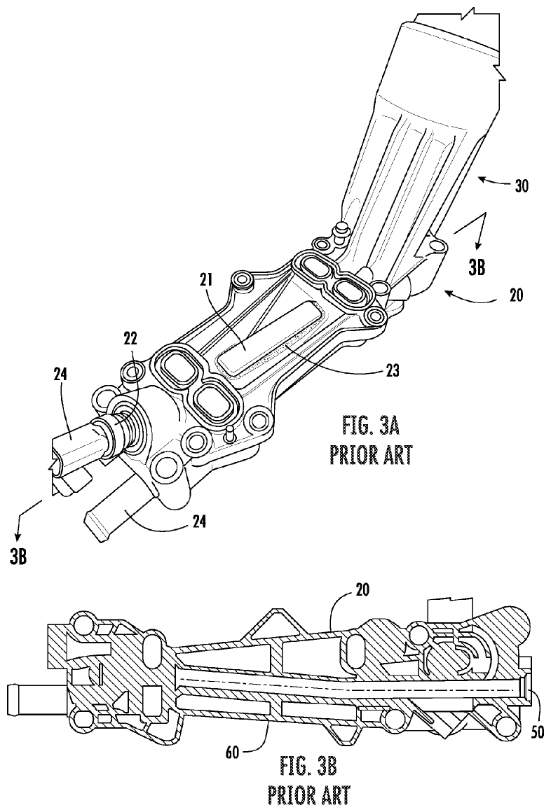

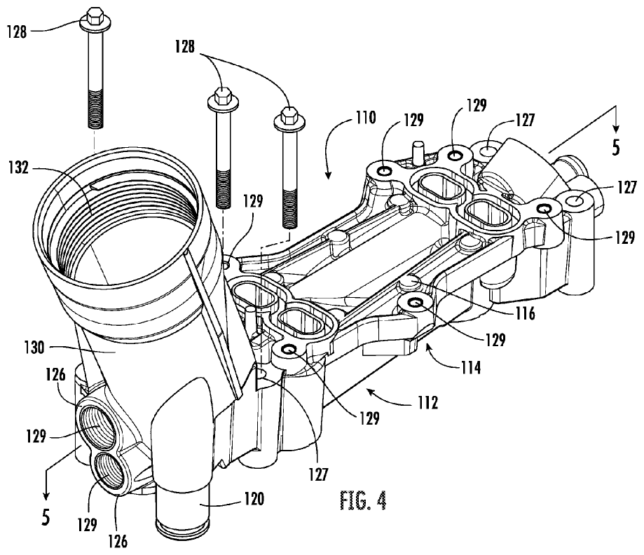

With reference to FIGS. 3A and 3B, it can be seen that the prior art flow path 50 requires a cover 21, at least partially over the flow path, that is adhered to the base after the molding core is removed by the adhesive or welding 23. With reference to FIG. 4B, it can be seen that the flow path 50 bends or is angular; in other word, the flow path 50 does not have a common longitudinal axis.

With reference to FIG. 4, the preferred adaptor 110 has an elongated body 112, which has a lower surface 114 that mates with a lubrication network and an upper surface 116 that mates with a cooling component, a filter housing 130 and base 120 that is formed of a casted metallic material, preferably aluminum. The elongated body 112, base 120 and the filter housing 130 are casted together and the apertures 127 for receiving the bolts 128 do not required metal inserts or sleeves to avoid stressing or cracking do to the solid metallic construction. The casting is also threaded at 129 to receive fasteners for securing an oil cooler 40 and external connectors to the adaptor 110.

Still with reference to FIG. 4, the casted filter housing 130 has internal threaded 132 that mate with an OEM cap 32 to secure a filter within housing 130. In a similar manner, the apertures 126 have internal threading to preferably mate with NPT plugs that are self-sealing. Depending on the type and construction of related components, such as sensors, it may be necessary to employ a gasket or sealing rings with their assembly.

With reference to FIG. 5, the flow path 150 for transporting the lubricant within base 120 to connect with the internal lubrication network is centered about the longitudinal axis 160 and consistent throughout the base 120. The flow path 150 is symmetric about the axis 160 and there is no angular component in the flow path 150 as it is connected with the internal lubrication network. The flow path 150 is entirely within the unitary casting so there is no need for adding a closure to the flow path.

With the exception of the flow path 150, the lubrication galleries and the location positions for associated components are identical to the OEM assembly so the casted metal adaptor is a direct replacement for the OEM part and no modifications or relocations of other components are necessary.

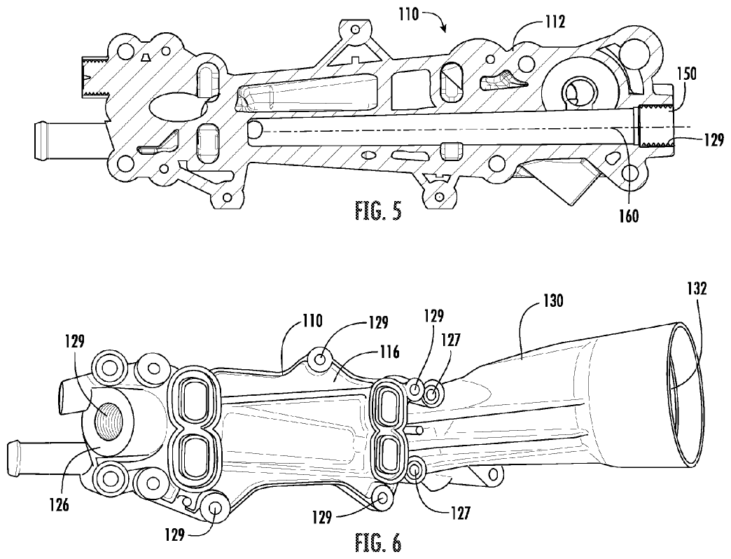

As shown in FIGS. 4 and 6, the adaptor 110, including the filter housing 130 and the base 120 outwardly appearance the same as the OEM part and the base accepts the OEM cooler 40 and the filter housing accepts the cap 32 without any modification.

What is claimed is:

1. A method for manufacturing a unitary metallic adaptor for an engine lubrication system, the method comprising the steps of:
casting an elongated unitary metallic body having:
a filter housing at a first end of the elongated unitary metallic;
a lower surface configured to mate with a lubrication system in an engine;
an upper surface between the filter housing and a second end that is configured to mate with a lubrication cooler;
an internal lubrication flow path that extends between the lower surface configured to mate with a lubrication network in an engine and the filter housing; and,
a plurality of casted apertures in at least one end of the elongated unitary metallic body; and,
threading at least one of the plurality of casted apertures for mating with a respective threaded member.

2. The method of claim 1, comprising the further step of threading each of the plurality of casted apertures in the least one end of the elongated unitary metallic body for mating with a respective threaded member.

3. The method of claim 1, comprising the further step of centering the internal lubrication flow path about a longitudinal axis extending between the filter housing and the second end.

4. The method of claim 1, comprising the further step of providing a plurality of apertures in the upper surface for attaching a lubrication cooler.

5. The method of claim 4, comprising the further step of threading each of the plurality of apertures in the upper surface for attaching a lubrication cooler.

6. The method of claim 1, comprising the further step of providing threads in a free end of the filter housing to receive a thread closure.

7. The method of claim 6, comprising the further steps of providing a plurality of threaded apertures in the upper surface for attaching a lubrication cooler and internal threads in a free end of the filter housing.

8. A method for manufacturing an adaptor for engine lubrication system, the method comprising the steps of:
casting a unitary metallic body having:
a filter housing at a first end of the unitary metallic body;
a lower surface of the unitary metallic body configured to mate with an engine lubrication system;
an upper surface of the unitary metallic body between the filter housing and a second end of the unitary metallic body that is configured to mate with a lubrication cooler;
an internal lubrication flow path that extends through the unitary metallic body to mate with an engine lubrication network and the filter housing;
at least one casted aperture in the unitary metallic body; and,
internally threading at least one casted aperture for mating with an externally threaded member.

9. The method of claim 8, comprising the further step of providing a plurality of casted apertures in the unitary metallic body and threading each of the plurality of casted apertures for mating with a respective threaded member.

10. The method of claim 8, comprising the further step of providing a plurality of apertures in the upper surface for attaching a lubrication cooler.

11. The method of claim 10, comprising the further step of threading each of the plurality of apertures in the upper surface for attaching a lubrication cooler.

12. An adaptor for engine lubrication system made by a process comprising:
casting a metallic body having:
a filter housing at a first end of the metallic body;
a lower surface on the metallic body configured to mate with an engine lubrication system;
an upper surface on the metallic body between the filter housing and a second end of the metallic body is configured to mate with a lubrication cooler;
an internal lubrication flow path that extends through the metallic body to connect the lower surface on the metallic body with the filter housing; and,
at least one casted aperture in the metallic body; and,
internally threading the at least one casted aperture for mating with an externally threaded member.

13. The process of claim 12, further comprising casting a plurality of apertures in the metallic body.

14. The process of claim 13, wherein each of the plurality of casted apertures is internally threaded for mating with a respective externally threaded member.

15. The process of claim 12, further comprising casting a plurality of casted apertures in the upper surface for mating with a lubrication cooler.

16. The process of claim 15, further comprising internally threading the plurality of casted apertures for mating with a lubrication cooler for mating with a respective threaded member.

17. The process of claim 12, further comprising centering the internal lubrication flow path about a longitudinal axis extending between the filter housing and the second end of the metallic body.

18. An adaptor for engine lubrication system made by a process comprising:
casting a metallic body having:
a filter housing at a first end of the metallic body;
a first surface configured to mate with an engine lubrication system;
a second surface between the filter housing and a second end of the metallic body that is configured to mate with a lubrication cooler;
an internal lubrication flow path that connects the second surface with the filter housing; and,
at least one casted aperture; and,
internally threading the at least one casted aperture for mating with an externally threaded member.
